(19) United States
(12) Patent Application Publication
(10) Pub. No.: US 2011/0157647 A1
(43) Pub. Date: Jun. 30, 2011

(54) Replaceable Printer Component Including Memory Storing Data Defined by Tags and Sub-Tags

(76) Inventors: Stephen D. Panshin, Corvallis, OR (US); Jacob Grundtvig Refstrup, Vancouver, WA (US); Jefferson P. Ward, Brush Prairie, WA (US)

(21) Appl. No.: 12/994,445

(22) PCT Filed: May 29, 2008
(86) PCT No.: PCT/US08/65109

§ 371 Date: Nov. 23, 2010

(51) Int. Cl. G06F 15/00

(52) U.S. Cl. 358/1.15

(57) ABSTRACT

A replaceable printer component includes a memory and a communication link. The memory is configured to store data in each of a plurality of portions of the memory. Each portion is defined by a tag. Within a first portion of the memory defined by a first tag, the data within the first portion is stored in a plurality of sub-portions of the first portion. Each sub-portion is defined by a sub-tag. The communication link is configured to communicatively link the memory to a printer controller when the replaceable printer component is installed in a printing system.

### RELATED APPLICATIONS

The present application claims the priority under 35 U.S.C. 119(a)-(d) or (f) and under C.F.R. 1.55(a) of previous International Patent Application No.: PCT/US2008/065109, filed May 29, 2008, entitled “Replaceable Printer Component Including Memory Storing Data Defined by Tags & Sub-tags”, which application is incorporated herein by reference in its entirety.

### BACKGROUND

Current printing systems typically include one or more replaceable printer components, such as inkjet cartridges, inkjet printhead assemblies, toner cartridges, ink supplies, etc. Some existing systems provide these replaceable printer components with on-board memory to communicate information to a printer about the replaceable component, such as ink fill level, marketing information, etc.

The data stored in the on-board memory of a replaceable printer component may vary over the lifetime of a printing system into which the replaceable printer component is installed. In addition, the format of the data, such as the type, number, and/or order of the data fields, may also vary between replaceable printer components used within a printing system.

For these and other reasons, a need exists for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram illustrating one embodiment of a printing arrangement.

FIG. 2 is a table illustrating one embodiment of the format of data stored within a memory device of a replaceable printer component.

FIG. 3 is a table illustrating another embodiment of the format of data stored within a memory device of a replaceable printer component.

FIG. 4 is a flow diagram illustrating one embodiment of a method for using a memory device of a replaceable printer component.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

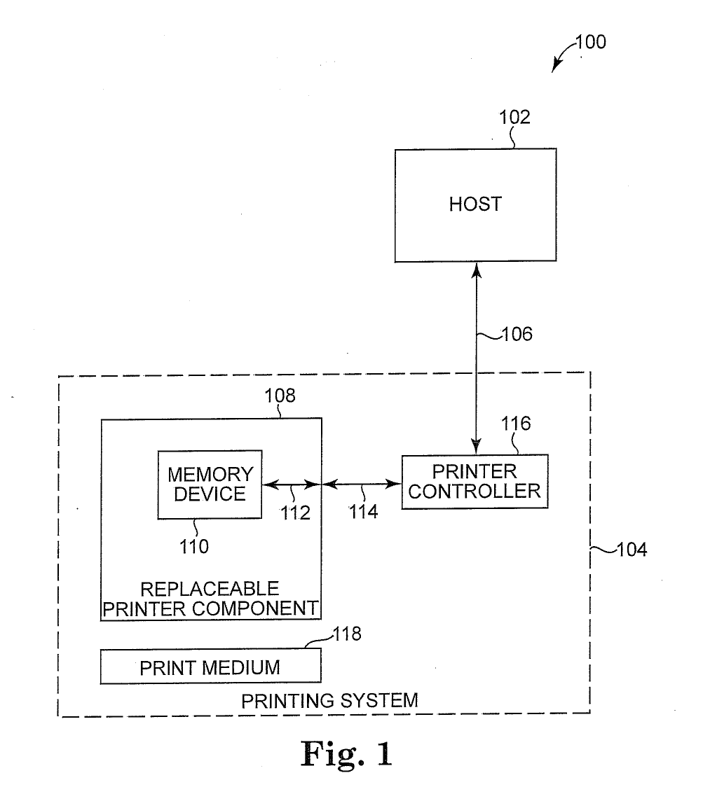

FIG. 1 is a block diagram illustrating one embodiment of a printing arrangement 100. Printing arrangement 100 includes a host 102 and a printing system 104. Printing system 104 facilitates printing of graphical and/or textural images on a print medium 118, such as paper, card stock, transparencies, Mylar, cloth, and the like. Printing system 104 includes, for example, an inkjet printer, a laser printer, or other suitable printer. Host 102 communicates with printing system 104 and provides data and/or control signals to printing system 104. Host 102 can be or can be included in a variety of information sources such as a computer, appliance, or other suitable device such as a personal digital assistant (PDA), digital camera, cellular phone, etc.

In one embodiment, printing system 104 includes a printer controller 116 and a replaceable printer component 108. Replaceable printer component 108 includes a memory device 110. In one embodiment, memory device 110 stores data in a plurality of blocks. The data stored in each block is preceded by an associated tag that identifies the type and the length of the data stored in the subsequent block. In one embodiment, memory device 110 stores data in a plurality of sub-blocks of a block. The data stored in each sub-block is preceded by an associated sub-tag that identifies the type and the length of the data stored in the subsequent sub-block.

Printer controller 116 controls the operation of printing system 104 and, as such, receives data and/or control signals from host 102. Printer controller 116 communicates with host 102 via a communication link 106. Communication link 106 includes, for example, an electrical, optical, infrared, or other suitable information transfer path between printer controller 116 and host 102.

Replaceable printer component 108 includes a component of printing system 104 that is insertable in and removable from printing system 104. In one embodiment, replaceable printer component 108 includes a consumable component that is disposed of and replaced at an end of a useful life thereof. An example of such a consumable component includes an ink container or a toner cartridge that contains a supply of marking material for printing system 104. The marking material is deposited on print medium 118 by printing system 104 and depleted during a useful life of the ink container or toner cartridge. As such, the ink container or toner cartridge is disposed of and replaced at an end of a useful life thereof or is remanufactured and reused.

In another embodiment, replaceable printer component 108 includes a printing component that is readily replaced in printing system 104. Examples of such a printing component include a printhead that selectively deposits ink on print medium 118 in response to control signals from printer controller 116 or a printer cartridge that includes a printhead and an ink supply. Thus, replaceable printer component 108 may include an ink container, a printhead, or a printer cartridge if, for example, printing system 104 includes an inkjet printer. In addition, replaceable printer component 108 may include a toner cartridge or a developer drum if, for example, printing system 104 includes a laser printer. Further, replaceable printer component 108 may include a peripheral device of printing system 104, such as an Ethernet card, a duplexer, a paper finisher (e.g., stapler, hole punch, etc.), or another suitable device.

Printer controller 116 and replaceable printer component 108 communicate with each other via a communication link 114. Communication link 114 facilitates information transfer between printer controller 116 and replaceable printer component 108 when replaceable printer component 108 is installed in printing system 104. Communication link 114 includes, for example, an electrical, optical, infrared, or other suitable information transfer path between replaceable printer component 108 and printer controller 116.

Replaceable printer component 108 includes a memory device 110 that stores information for replaceable printer component 108 and/or printing system 104. In one embodiment, memory device 110 includes a 256-byte or another suitably sized non-volatile memory, such as an EEPROM, FLASH, or another suitable memory. In one embodiment, memory device 110 stores, for example, information that is specific to replaceable printer component 108 and/or information that is applicable to printing system 104. In addition, memory device 110 can have information to be used by printing system 104 stored therein or can record information for printing system 104. In one embodiment, information that may be stored in memory device 110 includes operational and/or non-operational parameters for replaceable printer component 108 and/or printing system 104.

In one embodiment, replaceable printer component 108 includes a communication link 112 that electrically couples or communicatively couples memory device 110 with communication link 114 and, therefore, with printer controller 116 when replaceable printer component 108 is installed in printing system 104. As such, when replaceable printer component 108 is installed in printing system 104, memory device 110 communicates with printer controller 116 via communication links 112 and 114. Thus, communication links 112 and 114 include, for example, electrical couplings or connections such as electrical contacts or pins that mate with corresponding electrical nodes or receptacles, respectively.

In one embodiment, the data stored within memory device 110 is divided into a plurality of portions or blocks. The data stored in each portion or block is defined by an associated tag. An associated tag precedes the data stored in each block and identifies the type of data stored in the block and the length of the block. In one embodiment, each tag identifies a predefined number and order of data fields following the tag and the predefined length and meaning of each of the data fields. In another embodiment, a particular tag indicates that the data following the tag includes a variable number and order of data fields. In this case, the data following the tag is further divided into a plurality of sub-portions or sub-blocks. The data stored in each sub-portion or sub-block is defined by an associated sub-tag. An associated sub-tag precedes the data stored in each sub-block and identifies the type of data stored in the sub-block and the length of the sub-block.

With replaceable printer component 108 installed in printing system 104, printer controller 116 communicates with memory device 110 through communication links 112 and 114. Printer controller 116 reads the tags, sub-tags, and the data defined by the tags and sub-tags from memory device 110. Printer controller 116 interprets the tags and sub-tags and parses the data based on the interpreted tags and sub-tags. By interpreting the tags and sub-tags to parse the data, printer controller 116 does not need to be preconfigured to know the type, order, and length of all the data stored in memory device 110. Thus, the data stored within memory device 110 and the type, order, and length of the stored data may vary between replaceable printer components 108 during the lifetime of printing system 104.

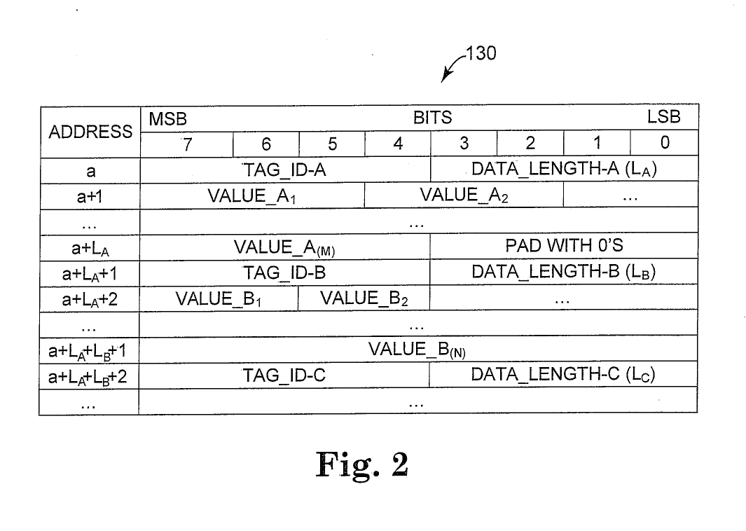

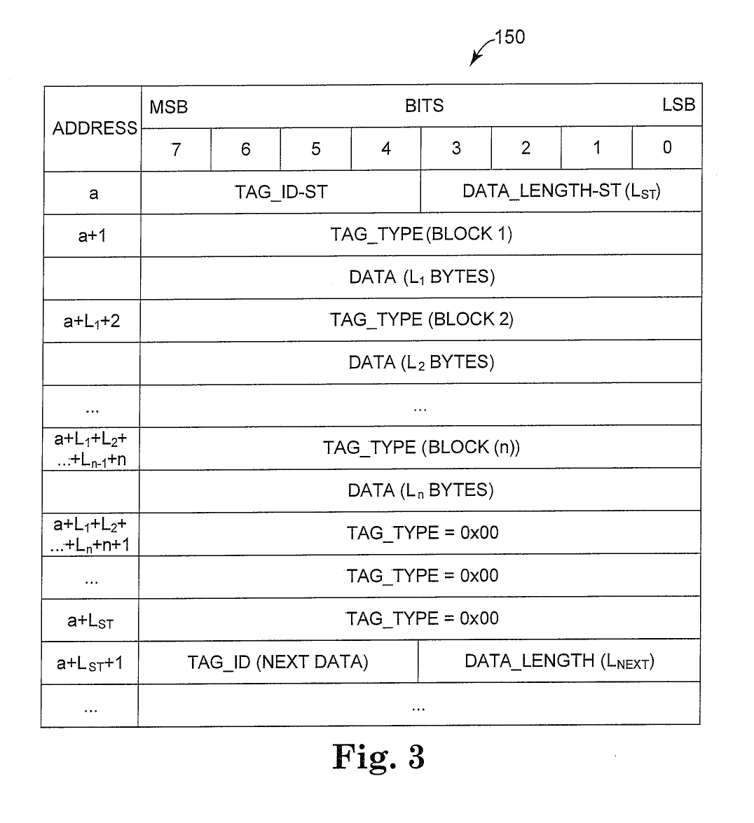

FIG. 2 is a table illustrating one embodiment of the format 130 of data stored within a memory device 110 of a replaceable printer component 108. Each block of data stored in memory device 110 is defined by a tag immediately preceding the block of data defined by the tag. Thus, the tags and each associated block of data may be stored in any order within memory device 110. Memory device 110 stores any suitable number of blocks of data defined by tags, such as 8 or 16 blocks of data. In one embodiment, each tag identifies the type of data associated with the tag including the order and number of data fields and the length and meaning of each data field within the block. In another embodiment, to be discussed below with reference to FIG. 3, a particular tag identifies that the associated data is further defined by sub-tags and organized into sub-blocks within a block. In the embodiment illustrated by FIG. 2, the illustrated tags are associated with previously defined and ordered data fields.

For example, at address “a”, bits “7 . . . 0” store a first tag. The first tag includes a 4-bit tag identification value (TAG_ID-A) followed by a 4-bit indication of the length of the data (DATA_LENGTH-A) stored in the subsequent block. In this embodiment, DATA_LENGTH-A indicates the subsequent block is L_{A}-bytes long. In one embodiment, TAG_ID-A identifies the number (“M”) and the order of the data fields stored within the subsequent block including the length and meaning of each data field. Thus, TAG_ID-A indicates that the subsequent block of data includes the predefined data fields given by: VALUE_A₁ (3-bits), VALUE_A₂ (3-bits), . . . VALUE_A(_{M}) (4-bits). In this embodiment, based on TAG_ID-A, it is known that VALUE_A₁ is stored at address “a+1”, bits “7 . . . 5” and VALUE_A₂ is stored at address “a+1”, bits “4 . . . 2”. Additional data fields are then stored in memory device 110 up to VALUE_A(_{M}), which is stored at address “a+L_{A}”, bits “7 . . . 4”.

The data length portion of the first tag stored at address “a”, bits “3 . . . 0” identifies the length of the subsequent block such that the location of the next tag can be determined. In one embodiment, DATA_LENGTH-A provides an integer number of bytes indicating the length of the subsequent block. In another embodiment, DATA_LENGTH-A provides a factor or an integer number of bytes that is multiplied by a constant, such as four, to determine the length of the subsequent block. In this embodiment, DATA_LENGTH-A indicates that the subsequent block of data is L_{A}-bytes long. The remaining bits identified by DATA_LENGTH-A that are not used to store data are padded with zeros as indicated at address “a+L_{A}”, bits “3 . . . 0”, or can be any value.

The next block of data stored in memory device 110 is identified by a second tag. The second tag includes TAG_ID-B and DATA_LENGTH-B stored at address “a+L_{A}+1”. TAG_ID-B identifies the number (“N”) and the order of the data fields stored within the subsequent block including the length and meaning of each data field. Thus, TAG_ID-B indicates that the subsequent block of data includes the predefined data fields given by: VALUE_B₁ (2-bits), VALUE_B₂ (2-bits), . . . VALUE_B(_{N}) (8-bits). In this embodiment, based on TAG_ID-B, it is known that VALUE_B₁ is stored at address “a+L_{A}+2”, bits “7 . . . 6” and VALUE_B₂ is stored at address “a+L_{A}+2”, bits “5 . . . 4”. Additional data fields are then stored in memory device 110 up to VALUE_B(_{N}), which is stored at address “a+L_{A}+L_{B}+1”, bits “7 . . . 0”. For this block of data identified by TAG_ID-B and DATA_LENGTH-B, all bits within the block store data. Additional blocks of data may be stored in memory device 110 as indicated by TAG_ID-C and DATA_LENGTH-C stored at address “a+L_{A}+L_{B}+2”.

In this embodiment, up to 16 different tag identification values can be defined and up to 16 different data length values can be defined. Each tag identification value defines any suitable number of predefined value fields where each value field has any suitable predefined length. In other embodiments, a different length tag identification value and/or a different length data length value is used such that more than 16 different tag identification values can be defined and/or more than 16 different data length values can be defined.

FIG. 3 is a table illustrating another embodiment of the format 150 of data stored within a memory device 110 of a replaceable printer component 108. In one embodiment, a particular tag identification value stored within memory device 110 indicates to printer controller 116 that the subsequent block of data includes sub-blocks of data. In one embodiment, the tag identification value is hardcoded in firmware of printing system 104. Each sub-block of data stored in memory device 110 is defined by a sub-tag immediately preceding the sub-block of data defined by the sub-tag. Thus, the sub-tags and each associated sub-block of data may be stored in any order within a block. In addition, a sub-tag and the associated sub-block may be repeated within a block. In one embodiment, each sub-tag identifies the type of data stored in the sub-block and the length of the sub-block.

For example, at address “a”, bits “7 . . . 0” store a tag. The tag includes the 4-bit tag identification value (TAG_ID-ST) followed by the 4-bit indication of the data length (DATA_LENGTH_ST). In this embodiment, TAG_ID-ST provides a particular tag identification value indicating to printer controller 116 that the subsequent block of data includes sub-blocks of data defined by sub-tags. Thus, the type, order, and number of data fields within the subsequent block may vary between replaceable printer components 108. In this embodiment, DATA_LENGTH-ST indicates that the subsequent block of data including the sub-blocks is L_{ST}-bytes long.

At address “a+1”, bits “7 . . . 0” store a first sub-tag (TAG_TYPE) for the first sub-block (BLOCK 1) of data. TAG_TYPE for BLOCK 1 indicates the type of data stored in the first sub-block and the length (L₁-bytes) of the first sub-block. In one embodiment, TAG_TYPE provides a single 8-bit value to indicate both the type and length of the data stored in the first sub-block. Therefore, in this embodiment, up to 256 unique sub-tags can be defined. In other embodiments, another suitable number of bits are used to provide each sub-tag such that a corresponding number of unique sub-tags can be defined. The data defined by TAG_TYPE for BLOCK 1 follows the first sub-tag beginning at address “a+2” and continues through address “a+L₁+1”.

At address “a+L₁+2”, bits “7 . . . 0” store a second sub-tag for the second sub-block (BLOCK 2) of data. TAG_TYPE for BLOCK 2 indicates the type of data stored in the second sub-block and the length (L₂-bytes) of the data stored in the second sub-block. The data defined by TAG_TYPE for BLOCK 2 follows the second sub-tag beginning at address “a+L₁+3” and continues through address “a+L₁+L₂+2”.

Additional sub-tags and the associated sub-blocks are then stored in memory device 110 up to a final sub-tag for the block. The final sub-tag for the block is stored at address “a+L₁+L₂+ . . . +Lₙ₋₁+n” for the final sub-block (BLOCK (n)) of data. The data defined by TAG_TYPE for BLOCK (n) indicates the type of data stored in the final sub-block and the length (Lₙ-bytes) of the data stored in the final sub-block. The data defined by TAG_TYPE for BLOCK (n) follows the final sub-tag beginning at address “a+L₁+L₂+ . . . +Lₙ₋₁+n+1” and continues through address “a+L₁+L₂+ . . . +Lₙ+n”. The remaining unused bytes identified by L_{ST} for TAG_ID-ST are padded with zeros by setting TAG_TYPE=0x00 as indicated at address “a+L₁+L₂+ . . . +Lₙ+n+1” through address “a+L_{ST}”. In another embodiment, the TAG_TYPE is set to another value to designate an unused sub-block. At address “a+L_{ST}+1”, the next block of data stored in memory device 110 is defined by the next tag including TAG_ID (NEXT DATA) and DATA_LENGTH (L_{NEXT}).

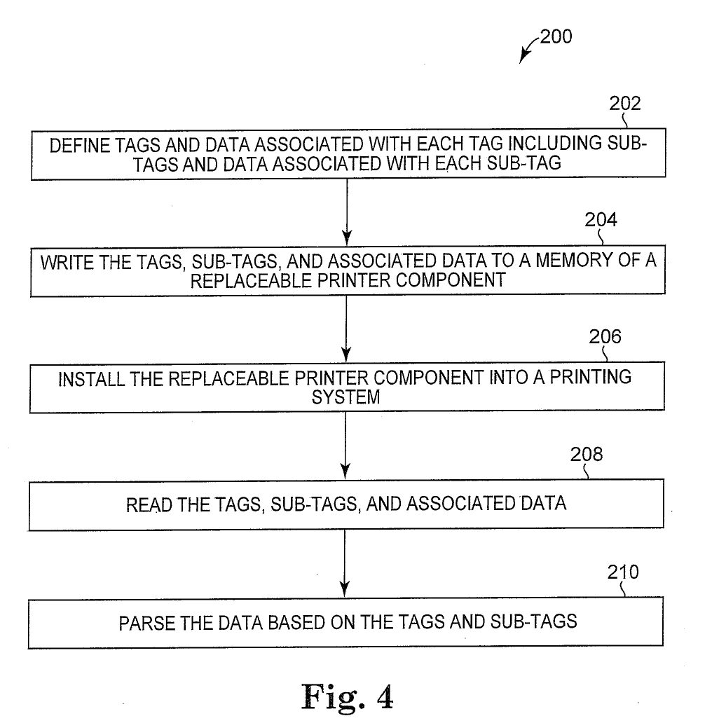

FIG. 4 is a flow diagram illustrating one embodiment of a method 200 for using a memory device 110 of a replaceable printer component 108. At 202, the tags and the data associated with each tag to be stored in memory device 110 are defined. In addition, for a tag whose associated data is defined by sub-tags, the sub-tags and the data associated with each sub-tag are also defined. Each tag defines the type of data to be stored in the subsequent block of data and the length of the subsequent block of data. Each sub-tag defines the type of data to be stored in the subsequent sub-block of data and the length of the subsequent sub-block of data.

At 204, the tags, sub-tags, and the data associated with each tag and each sub-tag are written to memory device 110 of replaceable printer component 108. In one embodiment, the previous process described by blocks 202 and 204 is performed by the manufacturer of replaceable printer component 108 during the manufacturing process of replaceable printer component 108.

At 206, a user installs replaceable printer component 108 into a printing system 104. With replaceable printer component 108 installed in a printing system 104, printer controller 116 establishes communications with memory device 110 through communication links 112 and 114. At 208, printer controller 116 reads memory device 110 including the tags, sub-tags, and the data associated with each tag and each sub-tag. At 210, printer controller 116 parses the data based on the tags and sub-tags.

Embodiments provide a replaceable printer component including a memory device. Memory device embodiments store data in blocks and sub-blocks defined by tags and sub-tags, respectively. A printing system in which a replaceable printer component embodiment is installed parses the data based on the tags and sub-tags during read operations. Therefore, the type, order, and length of data stored within memory device embodiments of a replaceable printer component may vary over the lifetime of the printing system.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A replaceable printer component comprising:
a memory configured to store data in each of a plurality of portions of the memory, each portion defined by a tag, wherein within a first portion of the memory defined by a first tag, the data within the first portion is stored in a plurality of sub-portions of the first portion, each sub-portion defined by a sub-tag; and
a communication link configured to communicatively link the memory to a printer controller when the replaceable printer component is installed in a printing system.

2. The replaceable printer component of claim 1, wherein each tag indicates a type and a length of the data stored in the portion defined by the tag.

3. The replaceable printer component of claim 2, wherein each tag provides a factor of the length of the data stored in the portion defined by the tag.

4. The replaceable printer component of claim 1, wherein each sub-tag indicates a type and a length of the data stored in the sub-portion defined by the sub-tag.

5. The replaceable printer component of claim 1, wherein each tag is stored in the memory immediately preceding the data defined by the tag, and
wherein each sub-tag is stored in the memory immediately preceding the data defined by the sub-tag.

6. The replaceable printer component of claim 1, wherein the replaceable printer component comprises one of an inkjet cartridge, an inkjet printhead assembly, a toner cartridge, and an ink supply.

7. The replaceable printer component of claim 1, wherein the replaceable printer component comprises a peripheral device of the printing system.

8. The replaceable printer component of claim 1, wherein the memory comprises a non-volatile memory.

9. A replaceable printer component comprising:
means for storing data in a plurality of blocks including a first block and for storing data in a plurality of sub-blocks of the first block;
means for defining the data stored in each block;
means for defining the data stored in each sub-block of the first block; and
means for communicatively linking the means for storing to a printer controller when the replaceable printer component is installed in a printing system.

10. The replaceable printer component of claim 9, wherein the means for defining the data stored in each block comprises means for defining a type and a length of the data stored in each block.

11. The replaceable printer component of claim 10, wherein the means for defining the type and the length of the data stored in each block comprises a first 4-bit value and a second 4-bit value associated with each block, each first 4-bit value indicating the type of data stored in the associated block and each second 4-bit value indicating a factor of the length of the data stored in the associated block.

12. The replaceable printer component of claim 9, wherein the means for defining the data stored in each sub-block comprises means for defining a type and a length of the data stored in each sub-block.

13. The replaceable printer component of claim 12, wherein the means for defining the type and the length of the data stored in each sub-block comprises an 8-bit value associated with each sub-block, each 8-bit value indicating both the type and the length of the data stored in the associated sub-block.

14. The replaceable printer component of claim 9, wherein the means for storing comprises a non-volatile memory.

15. The replaceable printer component of claim 9, wherein the replaceable printer component comprises one of an inkjet cartridge, an inkjet printhead assembly, a toner cartridge, and an ink supply.
